(19) United States
(12) Patent Application Publication
(10) Pub. No.: US 2023/0196560 A1
(43) Pub. Date: Jun. 22, 2023

(54) SYSTEMS AND METHODS FOR AUTOMATICALLY GRADING CANNABIS PLANTS AND ADJUSTING CONTROL PARAMETERS

(71) Applicant: SIGNIFY HOLDING B.V., EINDHOVEN (NL)

(72) Inventors: Jaehan KOH, CHESTNUT HILL, MA (US); Mathan Kumar GOPAL SAMY, MEDFORD, MA (US); Peter DEIXLER, ARLINGTON, MA (US); Tharakesavulu VANGALAPAT, QUINCY, MA (US); Sabrina Almeida DE CARVALHO, EINDHOVEN (NL)

(21) Appl. No.: 17/926,153

(22) PCT Filed: May 18, 2021
(86) PCT No.: PCT/EP2021/063166

§ 371 Date: Nov. 18, 2022

Related U.S. Application Data
(60) Provisional application No. 63/028,967, filed on May 22, 2020.

(30) Foreign Application Priority Data
Jun. 26, 2020 (EP) 20182487.7

(51) Int. Cl. G06T 7/00; G06V 10/25; G06V 10/771; G06V 10/88

(52) U.S. Cl. CPC G06T 7/0012; G06V 10/25; G06V 10/771; G06V 10/89; G06T 2207/30188

(57) ABSTRACT

A detection system (100) is disclosed herein. The system includes a sensor system (120) positioned to obtain image sensor data at different times of a live cannabis plant and a data storage system (130) configured to store the image sensor data. The system further includes a processor (140) coupled to the data storage system to receive the image sensor data. The processor includes a target region selection module (160) configured to determine a region of the live cannabis plant that contains a flower and generate a feature indicative of a characteristic of the flower. The processor further includes a grade estimation module (170) configured to estimate a qualitative assessment for the flower based on the feature and a temporal aggregation module (540) configured to combine the estimated qualitative assessments to output a final aggregated assessment.

### FIELD OF THE DISCLOSURE

The present disclosure is directed generally to systems and methods for automatically detecting/identifying one or more parts of a live cannabis plant and predicting a grade of the one or more parts of the live cannabis plant relative to historical and baseline data and controlling one or more sensor parameters to provide optimal environmental conditions for the live cannabis plant.

### BACKGROUND

The legal cannabis industry is currently one of the fastest growing segments in the world. Due to the increasing legalization in several countries as well as the rising adoption of cannabis as medical remedies for treating conditions such as Parkinson's disease, chronic pain, mental disorders, and cancers, the industry is expected to continue to experience substantial market growth. However, the cannabis industry has also been facing chronic over-supply issues and the price of cannabis has been in decline particularly as legalization expands. Therefore, there has been a need to raise the quality and reduce the cost of cannabis production.

Knowing the grade of a cannabis plant is important to growers and consumers. At the time of harvesting, farmers can benefit most from those plants that meet or exceed certain target grade levels. Thus, farmers can predict an amount of revenue based on the type of crop expected. Consumers can also benefit by having options to select a level of product they would like. Additionally, evaluating the quality of pistils and trichomes of a cannabis plant can allow farmers to predict when to harvest. Typically, cannabis grading systems involve human experts evaluating the product near or after harvesting. In one such system, the final grade is given by certified human experts considering visual factors and smell. Trichome methods for determining when to harvest require special equipment, such as, handheld magnifiers. Other methods of evaluating the quality of cannabis pistils and trichomes require supervised learning of dead leaves under polarized spectroscopy or supervised detection of live trichomes under a polarized light source. Unfortunately, such systems and methods can be very labor-intensive, subjective, error-prone, and expensive. Moreover, such systems and methods lack the ability to automatically control environmental parameters to improve or ensure the grade of the cannabis plant.

Accordingly, there is a need in the art for systems and methods for automatically and accurately predicting the grade or assessment of a live cannabis plant without human intervention. Additionally, there is a need in the art for systems and methods for automatically controlling one or more sensor parameters to improve and/or ensure the grade or rating of a live cannabis plant. There is also a need for systems and methods for evaluating cannabis pistils and trichomes without requiring microscopic or handheld imagers or polarized spectroscopy or lighting.

### SUMMARY OF THE INVENTION

The present disclosure is directed to inventive systems and methods for automatically estimating an ordinal grade of a live cannabis plant and automatically actuating control systems so that the plant receives optimal growing conditions to maintain or improve upon the estimated ordinal grade. In particular, embodiments of the present disclosure are directed to improved systems and methods for determining whether an image includes at least part of a cannabis flower using computer vision technologies and machine learning and predicting an ordinal grade of such identified flower parts. Various embodiments and implementations herein are directed to a grade detection system including a sensor unit, a data storage unit, and a processor where the processor includes a target region selection module, a grade estimation module, a temporal aggregation module, a life cycle detection module, a control parameter calculation module, and a feedback parameter control module. Artificial intelligence, machine learning, computer vision, and sensor networks and fusion enable automated systems and methods of accurately assessing the grade of live cannabis plants without human intervention.

Generally, in one aspect, a detection system is provided. The detection system includes a sensor system positioned to obtain first and second image sensor data of at least one part of a live cannabis plant, wherein the first and second sensor data are obtained at different times. The detection system further includes a data storage system configured to store the first and second image sensor data from the sensor system and at least one processor coupled to the data storage system to receive the first and second image sensor data of the at least one part of the live cannabis plant. The at least one processor includes a target region selection module configured to determine for each of the first and second image sensor data at least one region of the live cannabis plant that contains at least one part of a flower, wherein a feature indicative of a characteristic of the at least one part of the flower is generated by the target region selection module; a grade estimation module configured to estimate a qualitative assessment for the at least one part of the flower based at least in part on the feature generated by the target region selection module for the first and second image sensor data; and a temporal aggregation module configured to combine the qualitative assessments estimated for the first and second image sensor data to output a final aggregated assessment. The live cannabis plant is positioned in an indoor growth environment with artificial lighting only or a growth environment having both artificial lighting and natural lighting.

According to an embodiment, the sensor system includes at least one networked camera arranged to capture at least one bottom-view image of the live cannabis plant.

According to an embodiment, the at least one networked camera includes a RGB color sensor or an infrared sensor or a multispectral sensor or a multipixel thermopile sensor or a structured light sensor or a LiDAR sensor.

According to an embodiment, the at least one processor is further configured to compare the estimated qualitative assessment for the at least one part of the flower with a target qualitative assessment for the at least one part of the flower.

According to an embodiment, the at least one part of the flower is a pistil or a trichome and the at least one region is determined at least in part based on frequency filtering.

According to an embodiment, the at least one processor further includes a life cycle detection module configured to estimate a growth metric or a health metric based on the feature indicative of the characteristic of the at least one part of the flower and/or measure a growth deviation based on a comparison of the feature indicative of the characteristic of the at least one part of the flower with baseline data.

According to an embodiment, the at least one processor further includes a control parameter calculation module configured to determine at least one required control parameter for the live cannabis plant based on the estimated growth metric and/or the measured growth deviation.

According to an embodiment, the at least one processor further includes a control parameter calculation module configured to determine at least one required control parameter for capturing the at least one bottom-view image of the live cannabis plant.

According to an embodiment, the detection system also includes a lighting control system or a sensor control system and a feedback parameter control module in the at least one processor, wherein the feedback parameter control module is configured to learn at least one control parameter to attain a target qualitative assessment for the live cannabis plant.

Generally, in another aspect, a detection method for a live cannabis plant is provided. The method includes the steps of (a) obtaining, from a sensor system, first and second image sensor data of at least one part of a live cannabis plant, where the first and second image sensor data are obtained at different times; (b) storing the obtained first and second image sensor data in a data storage system; (c) receiving, at a processor, the first and second image sensor data of the at least one part of the live cannabis plant; (d) determining, by a target region selection module of the processor, for each of the first and second image sensor data at least one region that contains at least one part of a flower, the determining step comprising generating a feature indicative of a characteristic of the at least one part of the flower; (e) estimating, by a grade estimation module of the processor, a qualitative assessment for the at least one part of the flower based at least in part on the feature generated in the determining step for the first and second image sensor data; and (f) combining, by a temporal aggregation module of the processor, the qualitative assessment estimated for the first and second image sensor data to output a final aggregated assessment.

According to an embodiment, the sensor system includes at least one networked camera and the at least one networked camera is arranged to capture at least one bottom-view image of the live cannabis plant.

According to an embodiment, the at least one networked camera comprises a RGB color sensor or an infrared sensor or a multispectral sensor or a multipixel thermopile sensor or a structured light sensor or a LiDAR sensor.

According to an embodiment, the live cannabis plant includes a first strain variety and the detection method further comprises steps (a) through (f) for another live cannabis plant including a second strain variety.

According to an embodiment, the at least one part of the flower is a pistil or a trichome and the determining step includes frequency filtering.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the present disclosure.

FIG. 1 is a schematic depiction of a growth environment for one or more live cannabis plants according to aspects of the present disclosure;

FIG. 2 is an example grade detection system for one or more live cannabis plants according to aspects of the present disclosure;

FIG. 3 is an example process for predicting a qualitative assessment within a grade detection system for one or more live cannabis plants according to aspects of the present disclosure;

FIG. 4 is an example process for selecting regions of interest within a grade detection system for one or more live cannabis plants according to aspects of the present disclosure;

FIG. 5 is an example process for predicting a qualitative assessment within a grade detection system for one or more live cannabis plants including temporal aggregation according to aspects of the present disclosure;

FIG. 6 is an example flowchart showing a process for predicting a qualitative assessment for a live cannabis plant with temporal aggregation according to aspects of the present disclosure; and

FIG. 7 is an example process for evaluating pistils and trichomes for a cannabis plant according to aspects of the present disclosure.

### DETAILED DESCRIPTION OF EMBODIMENTS

The present disclosure describes various embodiments of systems and methods for providing optimal cannabis growing conditions so that a harvest satisfying a desired or target ordinal grading can be attained. More specifically, Applicant has recognized and appreciated that it would be beneficial to provide systems and methods having a sensor unit, a data storage unit, an algorithm unit, and an intelligent actuator unit to provide optimal cannabis growing conditions using image-based object detection and machine learning. The algorithm unit includes a target region selection module, a grade estimation module, a temporal aggregation module, a life cycle detection module, a control parameter calculation module, and a feedback parameter control module all of which enable reliable grade estimation and adjustment of control parameters. The intelligent actuator unit includes actuator mechanisms that can include a lighting control system, a camera control system, and/or one or more other sensor control systems to optimize the systems and methods. Exemplary goals of utilization of certain embodiments of the present disclosure are to accurately estimate a qualitative assessment of a cannabis plant while it is still growing and modify lighting, camera, or other sensor parameters to attain the highest quality cannabis plant.

Cannabis flowers can be rated by human experts based on their appearance, aroma, flavor, cure, and other effects. For example, the structure, density, resin (production and quality) and trim can be used to assess the appearance of a cannabis flower. The visible density of the individual flowers can correspond with certain carbon dioxide levels when the plant is flowering. Additionally, the presence of pistils and trichomes indicate the maturity of a plant. Thus, evaluating pistils and trichomes can allow farmers to predict when to harvest. The aroma of a cannabis flower can be indicative of a certain quality. For example, a high quality aroma of a cannabis flower has three or more noticeable or distinct characteristics. A well-cured flower can be evaluated by assessing how the flower feels and how it is dried. Flowers should be sticky from the resinous oils without being wet from its moisture content. A well-cured flower easily breaks down into pieces without becoming dusty or powder-like. The complexity and allure of the flavor of the flower can also be evaluated to indicate whether the flower is of high quality. The texture of edible and ingestible products can be evaluated to see if the flower adds to or detracts from the experience.

Sensors can be used to assess appearance, aroma, flavor, cure, and other effects of cannabis flowers to remove the subjective and error-prone nature of human evaluation. For example, the sensor system can include RGB, thermal, VoC (volatile organic compound), and gas sensors. Certain gas sensors can be used to measure the presence of particular gases. Other gas sensors can be used to measure the intake of particular gases. In embodiments, the sensor system can include additional sensors (e.g., aroma sensors) to carry out the systems and methods described herein.

Cannabis plants require different lighting conditions during the vegetative and flowering stages and depending on the particular strain of the plant. Amounts of gas, oxygen, and/or moisture required can also vary depending on the stage and strain. Thus, growers who produce cannabis indoors or within greenhouses with artificial and natural lighting can benefit from having systems and methods for controlling lighting and sensor parameters to attain the highest quality cannabis plants. The following systems and methods are applicable to any strain or combination of strains of cannabis plants. Some example strains include Acapulco Gold, Blue Dream, Purple Kush, Sour Diesel, Bubba Kush, Granddaddy Purple, Afghan Kush, LA Confidential, Maui Wowie, Golden Goat, Northern Lights, White Widow, Super Silver Haze, Pineapple Express, Fruity Pebbles, yet any strain or any combination of strains is contemplated under the Indica, sativa and hybrid types.

The present disclosure describes various embodiments of systems and methods for predicting an ordinal grade of live cannabis plants using artificial intelligence (AI) and machine learning and internet-of-things (IoTs) enabled sensors. Applicant has recognized and appreciated that it would be beneficial to estimate the ordinal grade of live cannabis plants using machine learning and computer vision in an automated fashion. Example embodiments are configured to autonomously detect the ordinal grade of live cannabis plants in farm and provide lighting and/or sensor parameters accordingly using machine learning algorithms and camera images to ensure or improve upon the estimated ordinal grade.

The term “live” as used in the present disclosure means the cannabis plant is growing over time and not yet dried. Thus, the process of determining an ordinal grade of a cannabis plant as described in the present disclosure is time sensitive and refers to a time period when the plant is still growing.

The term “ordinal grade” as used in the present disclosure refers to any scale of measurement that uses labels to classify cannabis plants into ordered classes. It is implied that each cannabis plant that falls into a particular grade is superior (or inferior) to every other classified cannabis plant that falls into another grade. Plants that fall within the same grade are considered equivalent. For example, a known grading system of this type is as follows: plants that receive a score between 0-69 are classified as “Unremarkable”; scores between 70-79 are classified as “Respectable”; scores between 80-84 are classified as “Good”; scores between 85-89 are classified as “Great”; scores between 90-94 are classified as “Amazing”; and scores between 95-100 are classified as “Extraordinary”. While this type of scale can be used by human experts when evaluating cannabis, the automated systems and methods as described in the present disclosure can also employ a similar scale. It should be appreciated that any suitable labels can be used in addition to the ones described above or as alternatives. Literal, numeric, and/or symbolic labels can be used. For example, “Extraordinary” can be replaced with “Exceptional”, “A+”, or “*****”, or any other suitable alternative. Similar alternatives can be used for the “Amazing”, “Great”, “Good”, “Respectable”, and “Unremarkable” labels. Additionally, it should be appreciated that the scores that define each of the six grades can be modified. For example, only scores between 98-100 can be classified as “Extraordinary” in some embodiments. Or, scores between 90-100 can be classified as “Extraordinary” in embodiments. As is appreciated with ordinal grading, the differences between the grades are not based on a quantifiable number. Instead, the differences are based on non-numeric concepts. For example, in the known grading system the difference between “Extraordinary” and “Amazing” is that “Extraordinary” embodies an exception expression of cannabis genetics while “Amazing” captures cannabis with remarkable characteristics. Similarly, a grade of “Great” captures a flower with special qualities whereas a grade of “Good” captures a solid, well-grown flower. A grade of “Respectable” captures an enjoyable flower that may have minor flaws. While the example grading system includes six grades, it should further be appreciated that other grading systems can have additional or few grades.

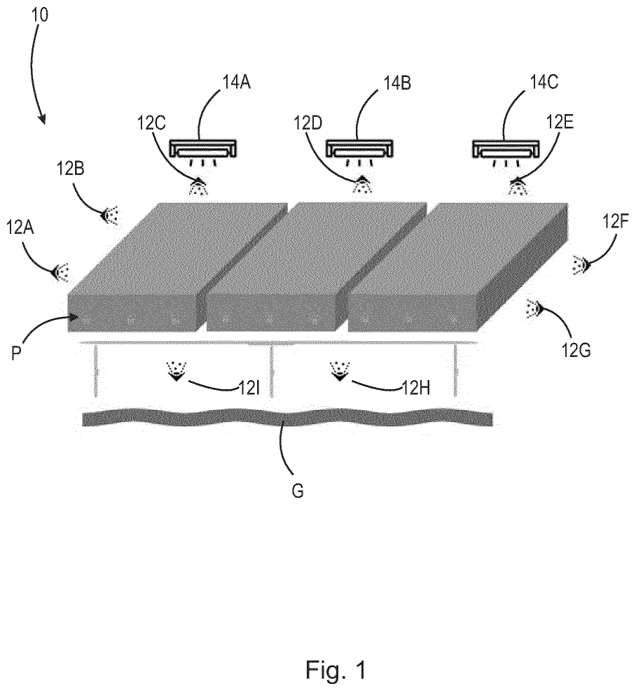

Referring to FIG. 1, a schematic depiction of a growth environment 10 for operating grade detection systems and methods for one or more live cannabis plants of the present disclosure is illustrated. The growth environment 10 includes a set of networked cameras 12A, 12B, 12C, 12D, 12E, 12F, 12G, 12G and 12I configured to collect image data of cannabis plants P growing in the systems and methods described herein and at least one luminaire 14A, 14B, and 14C to illuminate the cannabis plants P appropriately depending on the needs of the flowers. For example, the luminaires can be set to provide 12 hours of illumination during the flowering stage. The set of networked cameras 12A, 12B, 12C, 12D, 12E, 12F, 12G, 12G and 12I are positioned to obtain images of cannabis plants P in the growth environment 10. As depicted in FIG. 1, cameras 12A, 12B and 12F and 12G are positioned to obtain side-view images, cameras 12C, 12D, and 12E are positioned to obtain top-view images, and cameras 12H and 12I are positioned to obtain bottom-view images. As plants grow, leaves from taller plants can occlude the flowers of shorter plants resulting in unclear camera images. In these cases, the images from bottom-view cameras 12H and 12I can play an important role as they can capture images of the leaves and stem clearly. In embodiments, the bottom-view images are obtained with vertically arranged image sensors arranged directly underneath the plant(s). In alternate embodiments, the bottom-view images are obtained with image sensors that are arranged at an angle relative to the bottom side of the plant(s) such that a substantial portion of the bottom side of the plant(s) is within a field of view of the image sensor.

It should be appreciated that in other embodiments, additional or fewer cameras can be included and in any suitable arrangement. For example, in one embodiment, the networked cameras 12A-12I may be drones capable of moving around the growth environment 10 capturing top-, side-, and bottom-view images. In alternate embodiments, networked cameras 12A-12I are movable along one or more rail-mounted systems such that they have a high degree of freedom to capture information about each cannabis flower at various angles. It should be appreciated that with movable image sensors, only some of the images generated are bottom-view images. Additionally, although FIG. 1 depicts three luminaires, it should be appreciated that other embodiments can include additional or fewer luminaires in any suitable arrangement. The cannabis plants P in FIG. 1 are arranged above ground G. It should be appreciated that the growth environment 10 can represent an indoor system that relies completely on artificial lighting from the luminaires or a system that relies on artificial lighting from the luminaires and natural light.

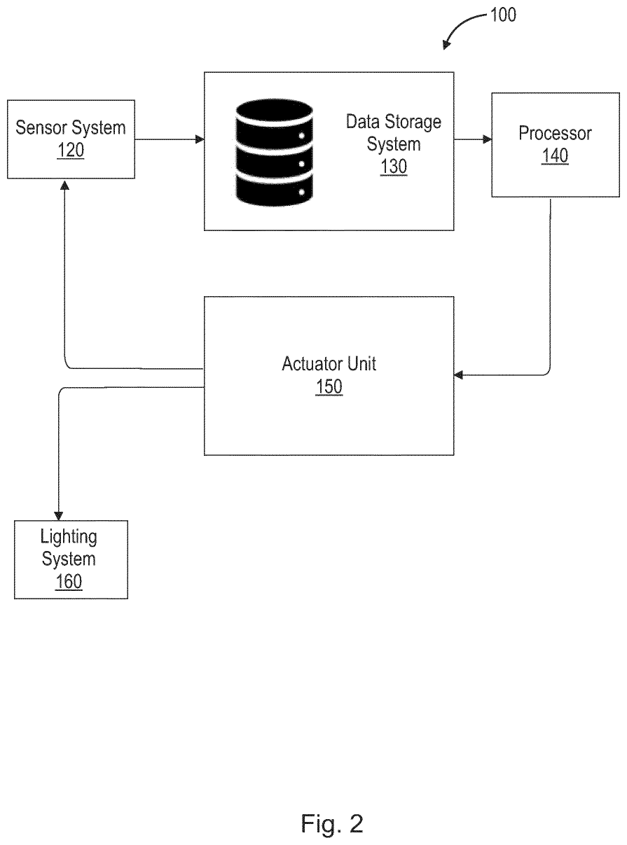

Referring to FIG. 2, an example grade detection system 100 for one or more live cannabis plants is illustrated. The grade detection system 100 includes a sensor system 120, a data storage system 130, at least one processor 140, an intelligent actuator unit 150, and a lighting system 160 as further described below. The grade detection system 100 is configured to detect and identify every plant and/or its parts in a growth environment (e.g., environment 10 in FIG. 1). Grade detection system 100 is further configured to segment, register, and track regions of interest (e.g., stem, leaf, flower) and predict an ordinal grade of the live cannabis plants with respect to historical and baseline information.

The sensor system 120 is configured to collect sensor data of live cannabis plants in a growth environment. In example embodiments, sensor system 120 includes networked sensors comprising multi-view RGB and/or near infrared sensors, multispectral sensors, multipixel thermopile sensors, structured light sensors, light detection and ranging (LiDAR) sensors, thermal sensors, VoC sensors, gas sensors, etc. The multi-view sensors are arranged to capture all views of the plant including front, rear, top, bottom, and side views. The cameras can also include those attached to mobile devices or a CMOS or CCD-based area array detector. The networked camera may also be used as a part of a structured-light 3D scanner (i.e., a 3D scanning device for measuring the three-dimensional shape of an object using projected light patterns and a camera system). The networked camera may also be used as part of a range imaging camera system that employs time-of-flight techniques to resolve distance between the camera and the object for each point in the image. Such a time-of-flight camera system can include one or more cameras each having a dedicated illumination unit and a data processing means and is capable of providing 3D images of an object by measuring the round-trip time of an artificial light signal provided by a laser or an LED. In example embodiments, networked cameras are arranged to capture top-, side-, and bottom-view images of the cannabis plants, for example, as shown in FIG. 1 with cameras 12A, 12B, 12C, 12D, 12E, 12F, 12G, 12H, and 12I. Other sensors of sensor system 120 are also configured to obtain information pertaining to the live cannabis plants. The sensor system 120 is coupled to the at least one processor 140 for analyzing the collected data.

The data storage system 130 is configured to store image data along with metadata in a cloud-enabled database. Data storage system 130 is also configured to store the data from the other sensors of sensor system 120. Data storage system 130 may also be configured to store logging information so that failures of the system can be analyzed and recovered properly. The data storage system 130 is also configured to store data for training of the deep neural network models such as masks for target regions of interest. Data storage system 130 provides real-time monitoring of cannabis plants P. System 100 can be configured to store such data by wired/wireless communication channels between the data storage system 130 and the at least one processor 140.

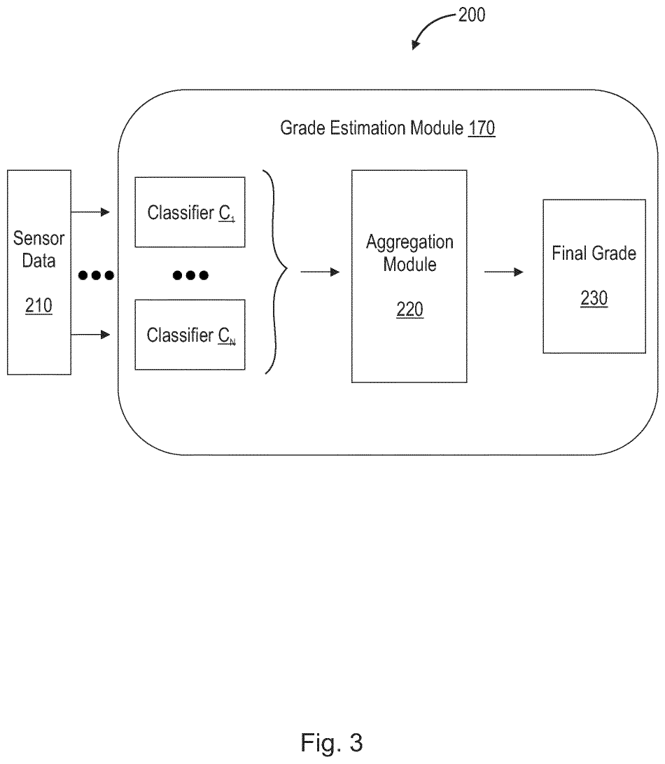

The at least one processor 140 is configured to detect and/or identify one or more plants and/or plant parts (e.g., leaves, flowers, stems) in an image, segment its parts in an image, predict the grade, learn control parameters for optimal data capture and optimal growth, estimate growth and health metrics, measure growth deviation, and generate optimal control parameters for the luminaires and the sensor system for the live cannabis plants. Image processing can be used to monitor plant health, for example, via disease detection. The sensor systems contemplated by the present disclosure can be optimized with control parameters to address lighting, fertilizer, irrigation needs as well as climate control and plant spacing needs by way of a few examples. Referring to FIG. 3, an example process 200 for predicting a qualitative assessment for one or more live cannabis plants is shown including a grade estimation module 170 of the at least one processor 140 configured to capture sensor data 210 (i.e., still or live feed images) from the sensor system 120 including the one or more networked cameras and/or use sensor data 210 from another camera (not shown) to perform image analysis. Any number of sources for the sensor data 210 is contemplated. In embodiments, the at least one processor 140 includes but is not limited to artificial intelligence, machine learning, sensor network and fusion, and computer vision algorithms to carry out the functionality described above. Also as shown in FIG. 3, one or more classifiers C₁ . . . C_{N} can be used to estimate an ordinal grade for the plant based on each individual sensor data 210. Additionally, the results can be combined by an aggregation module 220 to produce a final aggregated grade 230. Any number of classifiers can be used depending on the type of sensor data.

Processor 140 may take any suitable form, such as a microcontroller (or multiple microcontrollers), circuitry, a single processor (or multiple processors) configured to execute software instructions. Memory associated with the processor (not shown) may take any suitable form or forms, including a volatile memory, such as random-access memory (RAM), or non-volatile memory such as read only memory (ROM), flash memory, a hard disk drive (HDD), a solid-state drive (SSD), or other data storage media. The memory may be used by processor 130 for temporary storage of data during its operation. Data and software, such as the algorithms or software necessary to analyze the data collected by the networked cameras, an operating system, firmware, or other application, may be installed in the memory. A deep learning mechanism implemented by the processor or memory may be or may include an artificial neural network, a deep learning engine, or any other machine learning algorithm.

The processor 140 can include a single processor or multiple processors. For example, a first processor may control the networked cameras via a camera control module and obtain images from the cameras and a second processor may control the lighting and contain a light settings calculation module of the control parameter calculation module as described further below. The system 100 may also include a remote or centralized backend computer (not shown), e.g., one or more servers, databases, network equipment, or other computing hardware or devices having sufficient computing resources for performing calculations, making determinations, and storing data for the system 100 as discussed herein. The backend computer may include one or more processors, memory, and/or communication modules and may be implemented via cloud computing.

The intelligent actuator unit 150 of the grade detection system 100 broadly includes actuation mechanisms such as a lighting control system, a camera control system, and one or more sensor control systems configured to alter the amount of artificial and/or natural light, gas, oxygen, and/or moisture in a growth environment in response to instructions received from the at least one processor 140. In embodiments, the intelligent actuator unit 150 can automatically determine required sensor conditions and issue commands to the lighting, camera, and sensor control systems. In embodiments, the intelligent actuator unit 150 can provide sensor on/off schedule(s) and sensor recipe(s) according to the life cycle of the cannabis plants.

The lighting system 160 of the grade detection system 100 includes one or more luminaires as described above with reference to FIG. 1. Lighting system 160 is coupled with the at least one processor 140. Lighting system 160 can be embodied as any suitable configuration to allow selectable light output qualities. Such light-output qualities may include, for example, a spectrum of light including the presence or absence of one or more selected wavelengths or bands of wavelengths, a relative intensity of one or more wavelengths or bands of wavelengths in the spectrum, and aggregate light intensity. The lighting system 160 may be operated to control luminaire CRT (e.g., red, green, blue) outputs or correlated color temperature (CCT). The lighting system 160 may provide for multichannel color mixing. The luminaire may include fluorescent, high-intensity discharge (HID) metal halide (MH) lights and/or high pressure sodium (HPS) lights, ceramic metal halide (CMH) lights, incandescent, halogen, neon or LED light sources or a combination thereof. For example, the lighting system 160 may comprise one or more color-tunable, multichannel LED luminaires.

In example embodiments including a RGB sensor, multi-view images including at least one image from a bottom-view are collected from the sensor system 120. In order to estimate an ordinal grade of a cannabis flower, the detection system 100 analyzes the collected multi-view images to determine a region of interest (ROI) that contains at least part of a cannabis flower.

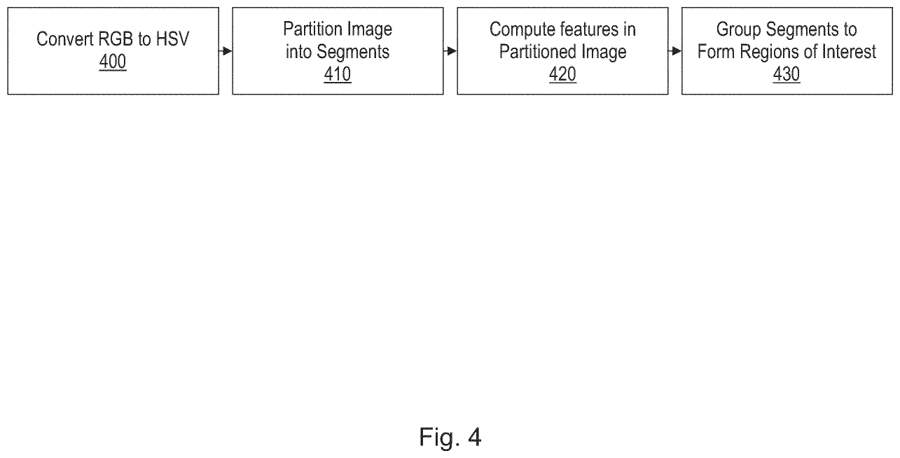

FIG. 4 shows an example process for selecting one or more ROIs within a grade detection system for one or more live cannabis plants according to embodiments of the present disclosure. The at least one processor 140 may use sensor system 120 to obtain still or live feed images to perform image analysis to segment, register, and track ROIs. In FIG. 4, a target region selection module 160 of the at least one processor 140 converts RGB sensor outputs into HSV (hue, saturation, value) values for each image obtained at step 400. Since all three channels of a RGB sensor can be affected by light intensity, (e.g., shadows), HSV values are used instead. HSV values encode color information in the hue channel which is invariant to changes in lighting. The saturation value of HSV values is insensitive to brightness changes as well. After the conversion, the target region selection module 160 partitions each image into a set of segments at step 410. An example segment is 4×4 pixels however, it should be appreciated that any suitable size is contemplated. Given the partitioned set of image segments, a similarity measurement is calculated for one or more features indicative of a characteristic of a part of a cannabis plant. The one or more features can include color, size, shape, texture, and surface texture at step 420. At step 430, the target region selection module 160 groups segments together to form ROIs.

In embodiments, a semantic segmentation algorithm, such as Mask R-CNN as described in “Mask R-CNN” by He et al., 2017, can be used to segment the images of live cannabis plants into its plant parts. A standard convolutional network such as InceptonV2, ResNet, and Xception can be selected as a deep learning mechanism and provided with images of cannabis plants having varying degrees of quality. The convolutional network can serve as a feature extractor. For example, given a 640×480×3 image, the model generates a feature map of 32×32×1024. The feature map can be used as an input for subsequent layers. For example, the processor 140 can input the convolutional feature map into a region proposal network (RPN). In such examples, the RPN can evaluate the convolutional feature map and generate proposals (e.g., object candidate locations) on the convolutional feature map. For example, a RPN can generate approximately 300 region proposals per image where the RPN scans each region and determines if a flower or a part of a flower is present. The RPN uses size, color, texture, and shape information of the image. Then, ROIAlign as described in “Mask R-CNN” can force every ROI to have the same size. ROIAlign is a layer configured to fix location misalignment caused by quantization in ROI pooling.

The processor then takes the ROIs proposed by the RPN as inputs and outputs a classification label (e.g., through a softmax operation) and a bounding box (e.g., through regressor). The classification label refers to specific qualitative flowering aspects. The bounding boxes identify candidate flowering aspects based on probability/classification scores that are larger than a fixed threshold. For example, a box with a classification score that is >0.5 can be considered a potential flower aspect. In the final step of the semantic segmentation, the ROIs are taken in as inputs and pixel masks with float values are generated as outputs for the plants and/or plant parts.

Although the present disclosure describes a semantic segmentation algorithm for segmenting images, such as Mask R-CNN, it should be appreciated that any other suitable algorithm can be used instead. For example, bidirectional long short-term memory (LSTM) neural networks can be used. In addition to semantic segmentation algorithms, classical segmentation and/or instance segmentation algorithms can be used or any other suitable alternative. Suitable alternatives include those algorithms that can: detect plants and/or its parts in a given image and segment, register, and track ROIs (stem, leaf, flower).

To determine whether a segmentation output contains an aspect of a flower of the live cannabis plant (versus leaves and stems), the at least one processor 140 can further include a binary classifier, for example, CNNs. An example network is characterized by a sequence of blocks each consisting of convolutional layers, max pooling layers and activation layers. At the end of the network, there are fully connected layers. During the training process, the network learns the optimal parameters using a large training set of images. Manually annotated labels for each image are also supplied as ground truths.

In embodiments of the grading detection system, only those areas of the image that are determined to contain flower aspects (i.e., foreground areas) are subjected to further processing. The background areas (i.e., leaves and stems) are not subjected to further processing. In example embodiments, the processor can have the networked cameras take one or more close-up images for better images on demand.

In example embodiments, the process for selecting one or more ROIs includes a trichome-specific frequency filtering algorithm configured to accurately segment pistil and trichome regions from a RGB image. In example embodiments, the specific frequency filtering includes Fourier Transform (FT) and frequency clipping to segment one or more foreground areas containing pistils and trichomes of a cannabis flower. Here, the basic assumptions are that (1) cannabis flowers are high frequency components in the RGB image, while other elements captured in the RGB image are not high frequency components and (2) background areas that include lighting fixtures do not have a green tint. For frequency filtering, the RGB image should be transformed into its corresponding frequency profile represented by a series of sine waves of various frequencies and phases. Based on the frequency profile, the algorithm removes or attenuates low frequency components as they belong to background areas. Then, the frequency profile is reconstructed back into an image focusing on the high frequency components (e.g., cannabis flowers) and filtering the low frequency components. Using any suitable thresholding techniques, the low frequency components can be clipped or removed.

Based on the features generated for foreground areas in the segmentation process, a grade estimation module 170 of the at least one processor 140 is configured to further analyze the data as described below.

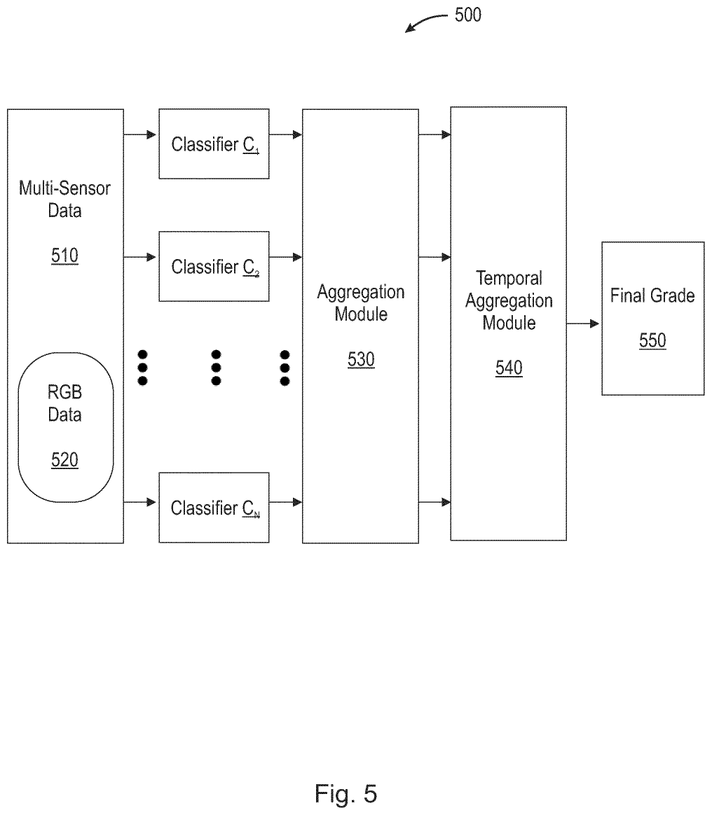

FIG. 5 shows an example process 500 for predicting a qualitative assessment within a grade detection system of one or more live cannabis plants according to aspects of the present disclosure. First, multi-sensor data 510 from sensors of the sensor system 120 can be fused together. The multi-sensor data 510 can include the multi-view RGB data 520 as described above. The fusion can embody combining data from multiple cameras at a certain time. Additionally or alternatively, channel information can be fused together. However, it should be appreciated that any suitable fusion is contemplated. In embodiments, the multi-sensor data 510 can be subsampled and randomized to reduce selection bias. Then, classification is performed for individual sensor data by classifiers C₁, C₂ . . . CN and aggregated by aggregation module 530. At least one classifier algorithm can be used however, any suitable number is contemplated. As shown in FIG. 5, example suitable classifier algorithms include support vector machines (SVM) C₁, random forest (RF) C₂, and artificial neural networks (ANN) C_{N}. However, it should be appreciated that any suitable classifier algorithms can be used to classify the individual sensor data.

Depending on the type of prediction, one or more of the following aggregation methods can be used by aggregation module 530: majority voting and weighted voting. In systems and methods incorporating majority voting, each classifier calculates a score for predicting an ordinal grade for a cannabis plant and the scores are added together with each score having an equal value. The prediction with the most votes above 50% determines the final predicted grade. In systems and methods incorporating weighted voting, each classifier has a vote but, some votes can be weighted more heavily than others. Thus, in embodiments weighted classifiers that calculate a score can be counted as more than a single vote depending on the weighting. It should be appreciated that any other suitable aggregation systems and methods can be used by aggregation module 530. For example, plurality voting could be used in alternate embodiments.

At the end of the process illustrated in FIG. 5, a temporal aggregation module 540 is employed to generate a final estimated grade 550 for the live cannabis plant. In example embodiments, a prediction from time T₁ can be combined with another prediction at time T₂ where the times T₁ and T₂ are different. Incorporating temporal information can overcome instances of misprediction. For example, sensor system can obtain measurement errors due to a variety of conditions in a growth environment, such as, when sprinklers are working in a watering cycle. In such a case, some sensors might not work properly resulting in erroneous grading. In another example, when the light is turned off during a grow cycle, the grade prediction will produce erroneous grading. While at least two predictions at times T₁ and T₂ can be combined, it should be appreciated that any number of predictions can be combined from time T₁ to T+l where l is a time range. Combining predictions of grades at different times increases accuracy.

Once the final estimated grade is determined, the grade detection system and methods described herein can benefit from a Q-learning-based feedback parameter control mechanism to change control parameters so that the final estimated grade can be ensured or improved upon. The at least one processor 140 can include a feedback parameter control module configured to learn control parameters necessary to attain a target ordinal grade for a cannabis plant. To do this, the feedback parameter control module accesses historical sensor data stored in the data storage system 130 and learns the optimal control parameters as described below. In embodiments, the feedback parameter control module comprises a model-free reinforcement-based algorithm. A behavior function that maximizes an expected sum of discounted rewards can be identified and control parameter states (s) can be mapped to actions (a). In this scenario, actions (a) refer to changing control parameters from state sₜ to sₜ₊₁. The Q-learning-based rule for updating states (s) can be expressed mathematically as follows:

Q[s, a]_{new}=Q[s, a]ₚᵣₑᵥ+α·(r+γ·max(s, a)−Q[s, a]ₚᵣₑᵥ)
where α is the learning rate,
r is reward for latest action,
γ is the discount factor, and
max(s, a) is the estimate of a new value from the best action.

If the optima value Q[s, a] of the sequence s′ at the next time step was known from all possible actions a′, then the optimal strategy is to select the action a* that maximizes the expected value of the following:

r+γ·max(s, a)−Q[s, a]ₚᵣₑᵥ

Based on the features generated for foreground areas in the segmentation process as described above, a life cycle detection module of the at least one processor 140 can be configured to further analyze the data to determine the stage of the life cycle of the plant. For example, the life cycle detection module can consider the size, texture, and shape of the flower or its part as well as the metadata of the image to determine an amount of time remaining until the plant will be ready to be harvested. The life cycle detection module can also compute growth metrics of the plant or its parts based on the size, texture, and shape of the flower over a period of time and/or in comparison to baseline data. Baseline data can be generated based on statistics from training of the processor. Historical data can be used to estimate normal growth values and actual growth values can be obtained and/or calculated and compared to the estimated normal growth values to determine growth deviations. Such growth deviations can be further evaluated to determine if control parameters of the sensor system or lighting system need adjustment as described herein.

A light settings calculation module of the at least one processor 140 can be configured to determine one or more lighting control parameters based at least on part on an amount of time remaining until the plant is ready to harvest and the target qualitative assessment desired. The lighting system 160 can receive signaling in accordance with one or more lighting control parameters determined by the light settings calculation module. A camera control module of the processor 140 can also be configured to determine one or more camera control parameters based at least in part on the amount of time remaining until the plant is ready to harvest. Camera control parameters can be optimized so that the networked cameras can obtain clear images of the cannabis plant parts for processing. For example, positional parameters of the networked cameras can be changed. Additionally or alternatively, the extent of zooming of the camera lens units can be adjusted so that close-up images can be obtained as described herein. The lighting control parameters and the camera control parameters can be fed into the actuator unit 150 so that it updates the control parameters.

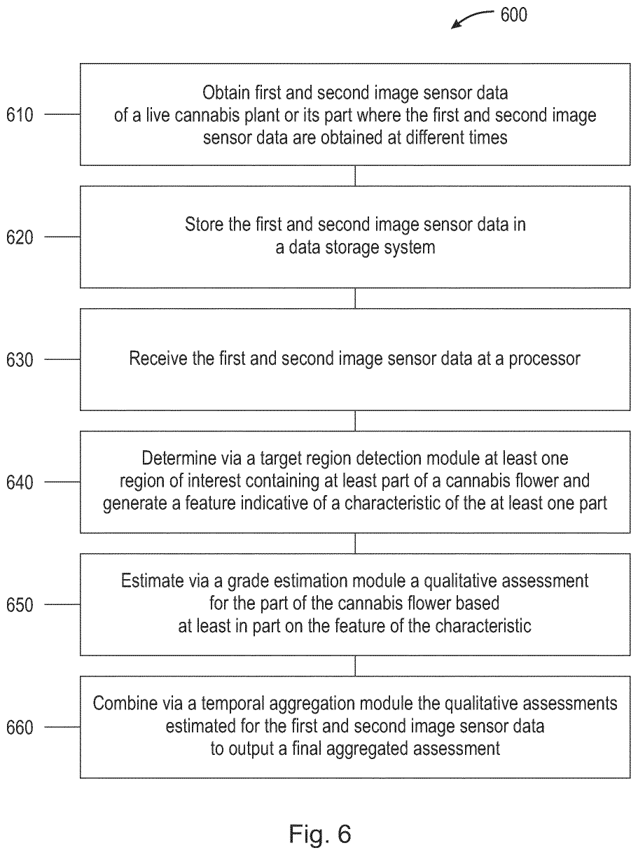

FIG. 6 shows an example flowchart of a process 600 for predicting a qualitative assessment for a live cannabis plant with temporal aggregation. At step 610, a sensor system (e.g., system 120) obtains first and second image sensor data (e.g., data 210, 510, 520) of at least one part of a live cannabis plant, where the first and second image sensor data are obtained at different times. At step 620, the first and second image sensor data is stored within a data storage system (e.g., data storage system 130). At step 630, at least one processor (e.g., processor 140) is configured to receive the first and second image sensor data to perform the image analyses described herein. Optionally, the data can be sampled and mixed as necessary.

At step 640, a target region selection module of the processor (e.g., module 160) is configured to determine for each of the first and second image sensor data at least one region of interest containing a flower of a live cannabis plant or at least one of its parts. The determining step 640 includes converting a RGB color space to an HSV color space, image partitioning, generating a feature indicative of a characteristic of the at least one part of the flower, and grouping segments together. The feature can include at least one of the following: color, size, shape, texture, and surface texture.

At step 650, a grade estimation module of the processor (e.g., module 170) is configured to estimate a qualitative assessment (e.g., a grade) for the at least one part of the flower based at least in part on the feature generated in the determining step. The grade estimation module performs grading in a multi-stage fashion. First, data from several sensors are subsampled and randomized to reduce selection bias. Second, classification is performed for individual sensor data and aggregated.

At step 660, a temporal aggregation module of the processor (e.g., module 180) is configured to combine the qualitative assessments estimated for the first and second image sensor data to output a final aggregated assessment. This fusion of temporal information assists with the determination of a final grade.

Optionally, parameter commands can be generated to change sensor settings so that the final grade can be ensured and/or improved upon. A Q-learning-based feedback parameter control mechanism as described herein can be employed.

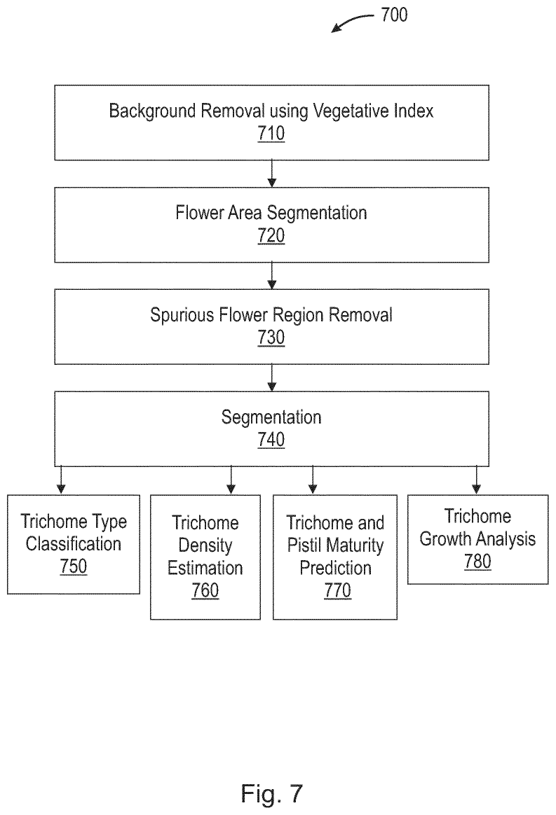

In FIG. 7, a process 700 for evaluating pistils and trichomes in a cannabis plant is shown. Steps 710-740 pertain to flower segmentation. Steps 710 and 720 relate to narrowing down the region(s) of interest. At step 710, a vegetative index is used to differentiate between background and foreground areas of an image. This is an example of a coarse-grained background removal method to optimize computational efficiency. In example embodiments, parts of lighting fixtures captured in the image can be differentiated and removed. An example suitable vegetative index can be calculated based on spectral bands that are sensitive to the high frequencies associated with the pistils and trichomes of cannabis plants. The vegetative index quantifies an amount of vegetation in each pixel. For example, yellow pixels can correspond to vegetation while blue pixels belong to non-vegetative components in the image. For example, lighting fixtures do not have a green tint so they could be captured in blue pixels after a vegetative index is applied. The blue pixels can be removed. Another advantage of using a vegetative index is that it does not require a supervised machine learning approach for trichome identification and characterization of trichome density.

At step 720, the foreground areas that contain pistils and trichomes are segmented. Segmenting the pistils and trichomes involves removing various types of noise and background pixels. In example embodiments, removal of noise and background pixels is based on one or more of the following: a vegetative index, frequency filtering, small blob removal, and maximal blob selection. Small blob selection and removal involves identifying a background area comprising a number of pixels that are all substantially similar in some manner (e.g., color). For example, a blob of blue pixels identifying a lighting fixture can be selected and removed. Assuming an image contains only a single flower, small blobs can be identified and removed since small blobs do not typically represent a single flower in an image. A maximal blob can be identified based on a largest number of pixels in the image that are substantially similar in one or more aspects. In example embodiments, a maximal blob selection process can be used to identify the segmented pistils and trichomes assuming the image contains a single flower. All the other non-maximal blobs can be removed as they do not contain the flower that is in the maximal blob.

Then, spurious flower areas are identified and removed at step 730. At this step, the assumption remains that a single image contains a single flower of interest.

Identifying spurious flower areas involves enhancing pixel blobs via thickening, for example, and isolating the largest blob. The largest blob is the region of interest that contains the largest flower in the image.

In example embodiments, enhancing blobs via thickening can be used to remove lighting fixtures during segmentation in addition to or as an alternative to the vegetation index and frequency filtering discussed above. After the pixels are thickened, the lighting fixture pixels that are not connected to the cannabis pixels can be removed. Any suitable morphological operation can used to achieve this functionality.

With the spurious flower areas removed, any suitable segmentation process proceeds at step 740 to identify regions containing pistils and trichomes of a cannabis plant.

Based on the identified regions containing pistils and trichomes as discussed above with reference to FIG. 7, a trichome type can be determined at step 750 via any suitable classification algorithm, a trichome density can be estimated at step 760, a trichome and pistil maturity can be predicted at step 770, and trichome growth can be further analyzed at step 780.

At step 750, identified regions containing trichomes can be further analyzed to determine if the trichomes are bulbous, capitate-sessile, or capitate-stalked. However, it should be appreciated that any aspect of the trichomes can be analyzed for identification. Bulbous trichomes are approximately 10-30 micrometers in length and are spread out across the surface of the plant sparsely. Capitate-sessile trichomes are approximately 25-100 micrometers in length and distributed across the surface of the plant more densely than bulbous trichomes. Capitate-stalked trichomes reach lengths of approximately 50-500 micrometers and typically produce the highest concentrations of a plant's unique chemical compounds.

At step 760, the density of the trichomes in the identified regions can be estimated to determine whether there is a sufficient amount of trichomes across the surface of the plant. Certain densities of the trichomes or density ranges can be associated with different quality levels.

At step 770, identified regions containing trichomes can be analyzed to estimate when they have reached maturity. For example, while the gland heads are typically clear or slightly amber in color at the beginning of the plant's growth cycle, the color of the gland heads becomes cloudy or opaque at maturity. The regions can be analyzed to determine when a certain portion of the identified trichomes have matured. Additionally or alternatively, the identified regions containing pistils can be analyzed to determine when the plants are ready to be harvested. For example, the color of the pistils changes from bright white to rusty orange or brown at the end of the plant's flowering phase.

At step 780, the identified trichomes can be further analyzed based on historical and/or baseline data to estimate growth metrics.

In additional embodiments, the data of the pistils and trichomes can be used to estimate yield (trichomes per square inch) in any suitable supervised approach. For example, daily or weekly estimates can be provided to estimate trichome yield.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A detection system, comprising:
a sensor system positioned to obtain first and second image sensor data of at least one part of a live cannabis plant, wherein the first and second sensor data are obtained at different times, the sensor system comprising at least one networked camera arranged to capture at least one bottom-view image of the live cannabis plant;
a data storage system configured to store the first and second image sensor data from the sensor system;
at least one processor coupled to the data storage system to receive the first and second image sensor data of the at least one part of the live cannabis plant, the at least one processor comprising:
a target region selection module configured to determine for each of the first and second image sensor data at least one region of the live cannabis plant that contains at least one part of a flower, wherein a feature indicative of a characteristic of the at least one part of the flower is generated by the target region selection module;
a grade estimation module configured to estimate a qualitative assessment for the at least one part of the flower based at least in part on the feature generated by the target region selection module for the first and second image sensor data; and
a temporal aggregation module configured to combine the qualitative assessments estimated for the first and second image sensor data to output a final aggregated assessment,
wherein the at least one processor further comprises a control parameter calculation module configured to determine at least one required control parameter for capturing the at least one bottom-view image of the live cannabis plant.

2. The system of claim 1, wherein the at least one networked camera comprises a RGB color sensor or an infrared sensor or a multispectral sensor or a multipixel thermopile sensor or a structured light sensor or a LiDAR sensor.

3. The system of claim 1, wherein the live cannabis plant is positioned in an indoor growth environment with artificial lighting only or a growth environment having both artificial lighting and natural lighting.

4. The system of claim 1, wherein the at least one processor is further configured to compare the estimated qualitative assessment for the at least one part of the flower with a target qualitative assessment for the at least one part of the flower.

5. The system of claim 1, wherein the at least one part of the flower is a pistil or a trichome and the at least one region is determined at least in part based on frequency filtering.

6. The system of claim 1, wherein the at least one processor further includes a life cycle detection module configured to estimate a growth metric or a health metric based on the feature indicative of the characteristic of the at least one part of the flower and/or measure a growth deviation based on a comparison of the feature indicative of the characteristic of the at least one part of the flower with baseline data.

7. The system of claim 6, wherein the at least one processor further includes a control parameter calculation module configured to determine at least one required control parameter for the live cannabis plant based on the estimated growth metric and/or the measured growth deviation.

8. The system of claim 1, further comprising a lighting control system or a sensor control system and a feedback parameter control module in the at least one processor, wherein the feedback parameter control module is configured to learn at least one control parameter to attain a target qualitative assessment for the live cannabis plant.

9. A detection method for a live cannabis plant, the method comprising:
(a) obtaining, from a sensor system, first and second image sensor data of at least one part of a live cannabis plant, where the first and second image sensor data are obtained at different times, and the sensor system comprises at least one networked camera arranged to capture at least one bottom-view image of the live cannabis plant;
(b) storing the obtained first and second image sensor data in a data storage system;
(c) receiving, at a processor, the first and second image sensor data of the at least one part of the live cannabis plant;
(d) determining, by a target region selection module of the processor, for each of the first and second image sensor data at least one region that contains at least one part of a flower, the determining step comprising generating a feature indicative of a characteristic of the at least one part of the flower;
(e) estimating, by a grade estimation module of the processor, a qualitative assessment for the at least one part of the flower based at least in part on the feature generated in the determining step for the first and second image sensor data; and
(f) combining, by a temporal aggregation module of the processor, the qualitative assessment estimated for the first and second image sensor data to output a final aggregated assessment,
wherein the processor comprises a control parameter calculation module configured to determine at least one required control parameter for capturing the at least one bottom-view image of the live cannabis plant.

10. The method of claim 9, wherein the at least one networked camera comprises a RGB color sensor or an infrared sensor or a multispectral sensor or a multipixel thermopile sensor or a structured light sensor or a LiDAR sensor.

11. The method of claim 9, wherein the live cannabis plant comprises a first strain variety and the detection method further comprises steps (a) through (f) for another live cannabis plant comprising a second strain variety.

12. The method of claim 9, wherein the at least one part of the flower is a pistil or a trichome and the determining step includes frequency filtering.
